(19) United States
(12) Patent Application Publication
(10) Pub. No.: US 2006/0021826 A1
(43) Pub. Date: Feb. 2, 2006

(54) Ring filter

(76) Inventors: Dirk Heintzen, Weisendorf (DE); Roger Meyer, Brighton, MI (US)

Correspondence Address: OSTROLENK FABER GERB & SOFFEN, 1180 AVENUE OF THE AMERICAS, NEW YORK, NY, 100368403, US

(21) Appl. No.: 11/192,879

(22) Filed: Jul. 29, 2005

Related U.S. Application Data
(60) Provisional application No. 60/592,940, filed on Jul. 30, 2004.

(51) Int. Cl. B01D 29/11

(52) U.S. Cl. 184/6.24; 210/483; 210/497.01

(57) ABSTRACT

A ring filter comprises a frame and a filter section. The frame comprises at least two first frame elements. One of the first frame elements is arranged on the axial front faces of the filter section and is fixedly connected thereto. The filter section extends in the axial direction between the two first frame elements. The filter section has a shape deviating from a straight line, as seen in longitudinal section. This significantly increases the effective filter surface and reduces throughflow resistance and the risk of the ring filter becoming clogged.

### CROSS REFERENCE TO RELATED APPLICATION

This application is based upon and claims benefit of U.S. Provisional Application 60/592,940, filed Jul. 30, 2004, to which a claim of priority is hereby made.

### BACKGROUND OF THE INVENTION

The invention relates to a ring filter for the filtration of pressure medium, having a filter section encircling the ring filter in the circumferential direction, and a frame comprising at least two first frame elements which bound the axial front faces of the filter section and are connected thereto.

Filters for the filtration of pressure medium and of lubricants are known for protecting sensitive components of a machine, which components are connected to a pressure-medium or lubricant circuit. The filters protect against dirt particles entering together with the pressure medium or lubricant. Components of this type may, for example, be hydraulic play-compensating elements, switchable cam followers of a valve-operating mechanism of an internal combustion engine, or hydraulic directional control valves, in particular sliding directional control valves. Machine parts of this type comprise a plurality of elements which move in relation to one another and are at a small distance from one another.

Hydraulic sliding directional control valves comprise, for example, a valve housing which is of essentially hollow-cylindrical design and has a plurality of connections and in which a control piston is arranged in an axially displaceable manner. The connections are designed as openings in the valve housing through which pressure medium can flow into the housing or can flow out of the housing. The openings lead generally into annular grooves which are formed in the outer circumferential surface of the valve housing. The outer circumferential surface of the control piston is of essentially cylindrical design and is essentially matched to the inner circumferential surface of the valve housing. Furthermore, the control piston is provided with a plurality of annular grooves spaced apart axially from one another. As a result, the connections of the directional control valve can either be connected to one another or separated from one another. If dirt particles enter the directional control valve, then there is the risk of them passing between the control piston and the valve housing and therefore leading to jamming of the directional control valve.

DE 100 27 080 C2 illustrates a 4/3-way directional control valve of this type for controlling a hydraulic camshaft adjuster. The pressure medium, the working connections and the tank connections are designed as annular grooves on an outer circumferential surface of the valve housing. In the groove bottoms, openings are formed in the valve housing. In order to prevent dirt from penetrating the interior of the directional control valve, a ring filter is arranged within each annular groove. Each of the ring filters comprises a filter section and a frame which encloses the filter section. The filter section is arranged in the axial direction between the frame elements and has in longitudinal section the shape of a straight line. The filters have essentially a C-shaped cross section, but with the two open ends of the filter facing each other. The two open ends are provided with interlocking means by means of which the filter can be closed after having been placed into the annular groove.

A disadvantage of this embodiment is the relatively small active surface of the ring filter. During operation of the internal combustion engine, if dirt particles accumulate in the filter section, then its active filter surface is reduced. In the worst case, this may lead to the filter becoming clogged. A further disadvantage arises from the fact that the relatively small filter surface presents a large resistance to the pressure medium passing through it. This resistance is increased in turn with the degree of soiling of the filter.

### SUMMARY OF THE INVENTION

The invention therefore has the object of avoiding these described disadvantages and of therefore providing a ring filter for filtering pressure medium, which has a sufficiently large active filter surface to avoid the filter becoming clogged and to keep the pressure loss of the pressure medium flowing through the filter as small as possible.

According to the invention, this object is achieved in that the shape of the filter section in longitudinal section deviates from a straight line. The filter section may be of arcuate or circular-arc-shaped design in longitudinal section. It is likewise conceivable for the filter section to be of n-cornered design in longitudinal section, where n>0. The filter section may be of concave or convex design in longitudinal section.

The ring filter essentially comprises a filter section and at least two first frame elements. The filter section has two open ends and is bent annularly, with the two open ends being situated opposite each other. The axial front faces of the filter section bent annularly are each bounded by a first frame element. The frame elements are connected to the filter section. The frame elements are likewise provided with two open ends which are opposite each other at a small distance. The opposite, open ends of the ring filter are provided with interlocking means which makes it possible to connect them to each other. In this case, the interlocking means are designed in such a manner that, in their closed state, dirt particles are prevented from being able to pass between the open ends.

The filter section has a shape deviating from a straight line in longitudinal section. Preferred embodiments have an arcuate, triangular or n-cornered shape. Owing to this design of the filter section, the active surface of the ring filter is significantly increased. As a result, the throughflow resistance of the pressure medium is reduced. The significant increase in the active filter surface has the further advantage that the throughflow of pressure medium is ensured, even if parts of the filter surface are covered by dirt particles. It is therefore not necessary to design the ring filter as a self-cleaning ring filter.

In one advantageous development of the invention, at least one second frame element is arranged between the first frame elements and is connected to the filter section.

The second frame element has a stiffening effect on the filter section and ensures that the latter retains its cross-sectional shape and therefore its enlarged active filter surface during operation of the internal combustion engine. In filter sections in an n-cornered embodiment, the second frame elements are advantageously arranged at the corners of the filter section.

Furthermore, the first frame elements and/or the first and the second frame elements are connected to cross struts. These cross struts assist in keeping the ring filter in its correct shape in the axial direction during the throughflow of pressure medium.

The ring filter is advantageously designed with two open ends which are bent annularly toward each other and are provided with fastening means, for fastening them to each other. This simplifies the installation of the ring filter at the desired location, since it can first be positioned in an open state. Then the open ends are fastened to each other.

In a further embodiment according to the invention, the ring filter is arranged within an annular groove in a rotary transmission lead through for pressure medium between a camshaft and a bearing shell formed on a cylinder head. The annular groove is placed into an inner circumferential surface of the bearing shell and communicates with a pressure medium line formed in the cylinder head and with at least one opening in the camshaft.

Alternatively, the ring filter can be arranged within an annular groove in a rotary transmission lead through for pressure medium between a camshaft and a bearing shell formed on a cylinder head. The annular groove is placed into the outer circumferential surface of the camshaft and communicates via at least one opening with a pressure medium passage in the camshaft and with a pressure medium line formed in the cylinder head.

In an advantageous manner, a ring filter can be designed according to one of the above-described embodiments.

Ring filters of this type are provided for use within annular grooves which enable pressure medium to be transmitted from a first machine part to a second machine part. A rotary transmission lead through within a camshaft mounting of a hub part designed as a camshaft bearing to a camshaft mounted therein is cited here as an example.

In a first configuration of the camshaft mounting, bores are placed into the hub part. These bores communicate with an annular groove placed into the inner circumferential surface of the hub part and from there the bores run essentially radially in the camshaft. In a second configuration, bores of the hub part communicate with an annular groove placed into the outer circumferential surface of the camshaft and the bores essentially run radially in the camshaft. In both cases, the ring filter is placed in the open state into the annular groove. In a first embodiment of the ring filter, in which the opposite, open ends are provided with interlocking means, the open ends are fastened to each other via the interlocking means. In a second embodiment, in which no interlocking means are provided, the open ends of the ring filters overlap in the circumferential direction. In both cases, the ring filter is designed in such a manner that dirt particles cannot penetrate between the open ends of the ring filter.

The ring filter is designed such that, in the closed state, a prestress is effective in such manner that the first frame elements bear fixedly against the camshaft or the hub. This prevents pressure medium from flowing past the filter section, between the frame elements and the adjacent component. Depending on which component the first frame elements are bearing against, the filter section is of concave or convex design, as seen in longitudinal section.

Camshafts generally have a larger diameter than the valve housing of a control valve. A ring filter fitted in the camshaft mounting therefore likewise has a larger diameter and therefore a larger active filter surface. This reduces the throughflow resistance during the passage of the pressure medium through the filter section and reduces the risk of the filter becoming clogged. The active filter surface can furthermore be increased by the use of a ring filter having a filter section which deviates in longitudinal section from the shape of a straight line.

Other features and advantages of the present invention will become apparent from the following description of the invention which refers to the accompanying drawings.

### BRIEF DESCRIPTION OF THE DRAWINGS

Further features of the invention emerge from the description below and from the drawings, in which exemplary embodiments of the invention are illustrated in simplified form. In the drawings:

FIG. 1a shows a perspective view of a first embodiment of a ring filter according to the invention,

FIG. 1b shows a perspective view of a second embodiment of a ring filter according to the invention,

FIGS. 2a to 2c show schematically, by way of example, three embodiments of the filter section of the ring filter according to the invention,

FIG. 3 shows a device for changing the timings of an internal combustion engine, which device is fastened to a camshaft which is mounted in a cylinder head, with a rotary transmission lead through for pressure medium between the cylinder head and the camshaft, and with a ring filter according to the invention integrated in the rotary transmission lead through.

### DETAILED DESCRIPTION OF A PREFERRED EMBODIMENT

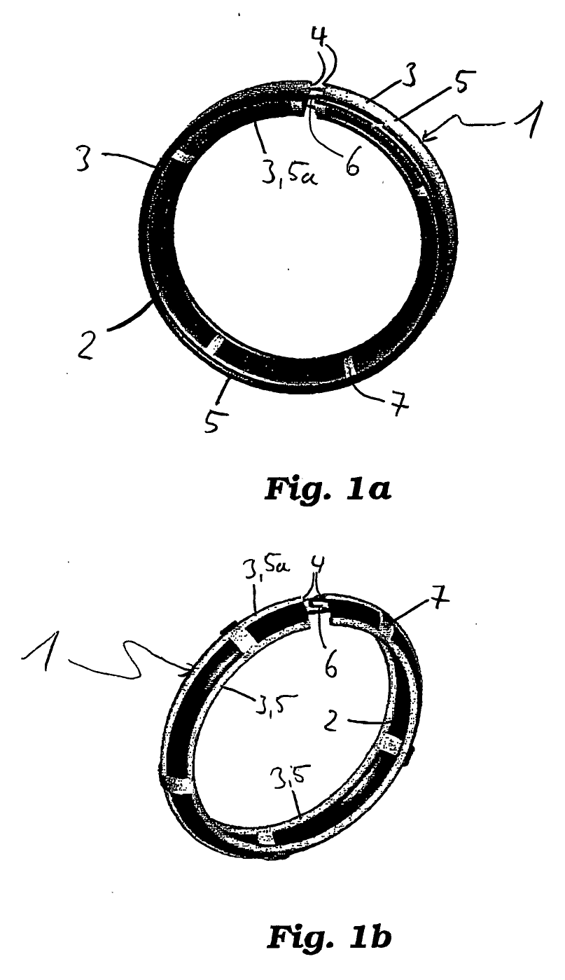

FIG. 1a shows a ring filter 1 according to the invention, comprising a filter section 2 and a frame 3. The filter section may be a filter screen or screen plate. Both the filter section 2 and the frame 3 are provided with open spaced apart ends 4, with the filter section 2 and the frame 3 being curved in a circular manner, so that the open ends 4 are situated opposite each other in a split ring form. The frame 3 comprises two first frame elements 5 and a second frame element 5a. In each case, a first frame element 5 is arranged on an axial front side of the filter section 2 and is connected to the filter section along the entire circumference of the filter section.

In the embodiment illustrated, the open ends 4 are provided with fastening means 6, so that the ends 4 can be fastened to each other. The fastening means are designed such that, in the closed state of the ring filter 1, the ends 4 bear fixedly against each other, such that no pressure medium can flow between the ends 4.

As an alternative to the above embodiment with fastening means, the ends 4 may overlap in the fitted state of the ring filter 1, which also ensures that the pressure medium does not flow past the filter section 2 and between the ends 4.

The filter section 2 is arcuate in cross section. It extends in an arcuate manner between the first frame elements 5. The arc extends in the direction of the center point of the ring filter 1. A shape of the filter section 2 that deviates from the straight line, as seen in longitudinal section, has the effect of significantly increasing the active filter surface. Consequently, the throughflow resistance experienced by the pressure medium during the passage through the ring filter 1 according to the invention drops in comparison to a ring filter described in the prior art. Furthermore, the enlarged effective filter surface reduces the risk of the ring filter 1 becoming clogged. Consequently, the ring filter 1 does not have to be designed as a self-cleaning ring filter.

To ensure the arcuate shape of the ring filter 1 during the throughflow of pressure medium, a second frame element 5a is arranged in the axial direction between the two first frame elements 5 and is connected to the filter section 2. The second frame element 5a, like the first frame elements 5, is a stiff, but nevertheless flexible, component and extends along the entire circumference of the filter section 2. The fixed connection of the second frame element 5a to the filter section 2, with the radius of the second frame element 5a being matched to the radius of the filter section 2, ensures that the shape of the filter section 2, which deviates in longitudinal section from the straight line, is also maintained during the throughflow of pressure medium through the ring filter 1.

Furthermore, cross struts 7 provided between the first frame elements 5 and the second frame element 5a prevent the ring filter 1 from being compressed in the axial direction during its installation or during the throughflow of pressure medium.

The ring filter 1 illustrated is adapted for insertion on an inner cylinder circumferential surface of a bore of a machine element or of an annular groove formed therein. The first frame elements 5 are designed with an outwardly directed prestress in such a manner that, in the fitted state, they bear pressure-tightly against the cylinder circumferential surface or against the groove bottom of the annular groove. As a result, the pressure medium approaching the ring filter 1 is prevented from flowing past the filter section 2 between the first frame elements 5 and the machine element.

FIG. 1b shows a further embodiment of a ring filter 1 according to the invention. This is virtually identical to the ring filter 1 illustrated in FIG. 1a. For that reason, the same reference numbers are used for the same components. The filter section 2 in turn is of arcuate design, as seen in longitudinal section. In contrast to the ring filter 1 illustrated in FIG. 1a, the arcuate filter section 2 extends away from the center point of the ring filter 1. In this case, the first and second frame elements 5, 5a are designed in such a manner that, in the fitted state, they are prestressed toward the center point. This ensures a pressure-tight bearing of the first frame elements 5 against a wavelike component.

In addition to the variants in which the filter section 2 is of arcuate design, as seen in longitudinal section, all shapes deviating from a straight line are possible, for example circular-arc-shaped, elliptical, triangular, four-cornered or n-cornered with n>2.

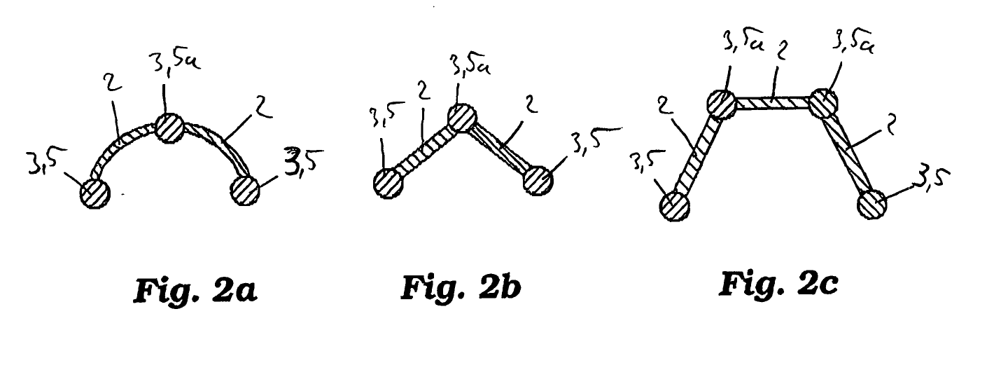

FIGS. 2a to 2c show three possible embodiments in a schematic illustration. FIG. 2a shows the embodiment illustrated in FIGS. 1a and 1b. The filter section 2 is of circular-arc-shaped design and is connected to the first and second frame elements 5, 5a. FIG. 2b shows a triangular embodiment and FIG. 2c shows a four-cornered embodiment. Furthermore, these embodiments may be of convex or concave design, i.e. they extend in the direction of the center point of the ring filter 1 or away therefrom.

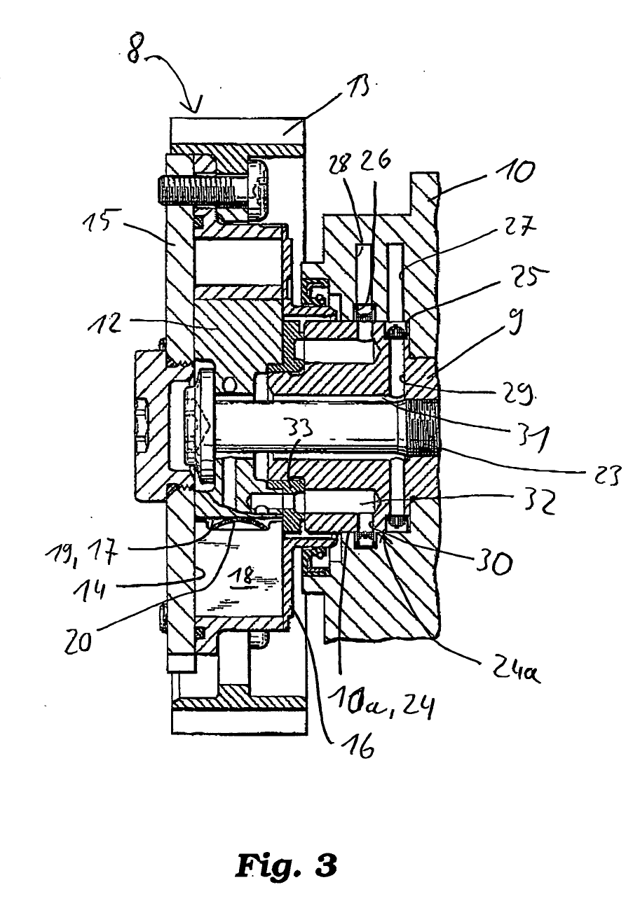

FIG. 3 shows a longitudinal section of a device 8 for adjusting the timings of an internal combustion engine, which device is fastened to a camshaft 9. The camshaft 9 is mounted in a bearing shell 10a of a cylinder head 10. The device 8 is arranged at the drive end of the camshaft 9. The device 8 essentially comprises a stator 11 and a driven part 12 arranged concentrically therewith. A driving wheel 13 is connected in a rotationally fixed manner to the stator 11 and, in the embodiment illustrated, is designed as a belt wheel. The stator 11 is mounted rotatably on the driven part 12, with a plurality of recesses 14 spaced apart in the circumferential direction provided on the inner circumferential surface of the stator 11. The recesses 14 are bounded in the radial direction by the stator 11 and the driven part 12, in the circumferential direction by two side walls (not illustrated) of the stator 11 and in the axial direction by a first and a second side cover 15, 16. Each of the recesses 14 is thereby closed pressure-tightly.

Wing grooves 17 running axially are formed on the outer circumferential surface of the driven part 12, with a radially extending wing or vane 18 being arranged in each wing groove 17. A wing 18 extends into each recess 14, with the wings 18 bearing in the radial direction against the stator 11 and in the axial direction against the side covers 15, 16. Each wing 18 divides a recess 14 into two pressure chambers operating in relation to each other. In order to ensure that the wings 18 bear pressure-tightly against the stator 11, spring elements 20 are fitted between the groove bottoms 19 of the wing grooves 17 and the wings 18 and act upon the wings 18 in the radial direction with a force.

By means of first and second pressure medium lines 21, 22, the first and second pressure chambers can be connected via a control valve (not illustrated) to a pressure medium pump (not illustrated) or a tank (not illustrated). As a result, an actuator is formed which permits the stator 11 to rotate relative to the driven part 12. In this case, provision is made for all of the first pressure chambers to be connected to the pressure medium pump and all of the second pressure chambers to be connected to the tank, or the reverse configuration. If the first pressure chambers are connected to the pressure medium pump and the second pressure chambers are connected to the tank, then the first pressure chambers extend at the cost of the second pressure chambers. This results in a displacement of the wings 18 in the circumferential direction. The displacement of the wings 18 causes the driven part 12 to rotate relative to the stator 11.

The driven part 12 is connected in a rotationally fixed manner to the camshaft 9 by a screw 23. The camshaft 9 is mounted rotatably in the cylinder head 10 by means of a plurality of friction bearings 24, one of which is illustrated. At the interface between camshaft 9 and cylinder head 10, a rotary transmission lead through 24a for pressure medium is formed in the region of the friction bearing 24. For this purpose, a first annular groove 25 is placed into the outer circumferential surface of the camshaft 9. Furthermore, a second annular groove is formed in the inner circumferential surface of the bearing shell 10a of the cylinder head 10. The first annular groove 25 communicates with a third pressure medium line 27. The second annular groove with a fourth pressure medium line 28. The third and the fourth pressure medium line 27, 28 are formed in the cylinder head 10. Furthermore, the annular grooves 25, 26 communicate with a first and second radial opening 29, 30, respectively, of the camshaft 9, with the openings 29, 30 leading into a first and second axial pressure medium passage 31, 32, respectively. The first pressure medium passage 31 communicates with the first pressure medium line 21 by means of a pressure medium adapter 33. The second pressure medium passage 32 communicates with the second pressure medium line 22. Pressure medium can then be conducted via the third and fourth pressure medium lines 27, 28, the annular grooves 25, 26, the openings 29, 30, the pressure medium passages 31, 32 and the pressure medium lines 21, 22 from a pressure medium connection (not illustrated) to the pressure chambers or from the latter to the pressure medium connection.

A respective ring filter 1 is arranged within the first and second annular grooves 25, 26. This prevents dirt or metal chips situated within the device 8 from passing to a control valve (not illustrated) which supplies pressure medium to the annular grooves 25, 26.

The annular grooves 25, 26 can be formed in the inner circumferential surface of the bearing shell 10a or in the outer circumferential surface of the camshaft 9. Depending in each case on the embodiment, use is made of a ring filter 1 with a filter section 2 which is of convex or concave design in longitudinal section.

An embodiment is also conceivable in which a control valve is arranged concentrically within the driven part 12 and is supplied with pressure medium via an annular groove 25, an opening 29 and a pressure medium passage 31 and conducts the pressure medium to the pressure chambers. In this case, provision is made for a ring filter 1 to be arranged within the annular groove 25. This ring filter 1 prevents metal chips or other dirt from penetrating the control valve.

A ring filter 1 according to the invention is advantageously used, with the filter section 2 of the ring filter 1 having a shape which deviates from a straight line, as seen in longitudinal section. Such a design of the filter section significantly increases the active filter surface, as a result of which the throughflow resistance during the passage of the pressure medium through the ring filter 1 and the risk of the ring filter 1 becoming clogged are reduced.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A ring filter for the filtration of hydraulic medium, comprising
a filter section encircling the ring filter in the circumferential direction, the filter section having axial front faces;
a frame comprising at least two first frame elements, which bound the axial front faces of the filter section and are connected thereto; and
the shape of the filter section in longitudinal section deviates from a straight line.

2. The ring filter as claimed in claim 1, wherein the filter section is n-cornered in longitudinal section, where n>0.

3. The ring filter as claimed in claim 1, wherein the filter section is of arcuate shape in longitudinal section.

4. The ring filter as claimed in claim 1, wherein the filter section is of circular-arc-shaped design in longitudinal section.

5. The ring filter as claimed in claim 1, wherein the filter section is concave in longitudinal section.

6. The ring filter as claimed in claim 1, wherein the filter section is convex in longitudinal section.

7. The ring filter as claimed in claim 1, further comprising at least one second frame element arranged between the first frame elements and being connected to the filter section.

8. The ring filter as claimed in claim 1, further comprising cross struts across the frame and the first frame elements are connected to the cross struts.

9. The ring filter as claimed in claim 7, wherein at least one of the first frame elements and the second frame elements are connected to cross struts.

10. The ring filter as claimed in claim 1, wherein the ring filter has two open ends which are bent annularly toward each other, and each open end includes a fastener, for fastening the open ends to each other.

11. A ring filter for use in a rotary transmission for the filtration of hydraulic medium, comprising
a rotary transmission including a bearing shell on a cylinder head and a camshaft in the bearing shell;
the bearing shell having an inner circumferential surface; an annular groove into the inner circumferential surface of the bearing shell, and the groove communicating with a pressure medium line in the cylinder head and with at least one opening in the camshaft;
a filter section encircling the ring filter in the circumferential direction, the filter section having axial front faces;
a frame comprising at least two first frame elements, which bound the axial front faces of the filter section and are connected thereto;
the ring filter is arranged within the annular groove in the rotary transmission lead through for pressure medium between the camshaft and the bearing shell formed on the cylinder head.

12. A ring filter for use in a rotary transmission for the filtration of hydraulic medium, comprising
a rotary transmission including a bearing shell on a cylinder head and a camshaft in the bearing shell;
a camshaft having an outer circumferential surface, an annular groove into the outer circumferential surface of the camshaft, the groove communicating with a pressure medium line in a cylinder head and with at least one opening in the camshaft;
a filter section encircling the ring filter in the circumferential direction, the filter section having axial front faces;
a frame comprising at least two first frame elements, which bound the axial front faces of the filter section and are connected thereto;
the ring filter is arranged within the annular groove in the rotary transmission lead through for pressure medium between the camshaft and the bearing shell formed on the cylinder head.
